(19) United States
(12) Patent Application Publication
(10) Pub. No.: US 2025/0092607 A1
(43) Pub. Date: Mar. 20, 2025

(54) SURFACE-TREATED GAS BARRIER FILM

(71) Applicant: Stora Enso OYJ, Helsinki (FI)

(72) Inventors: Kaj Backfolk, Lappeenranta (FI); Isto Heiskanen, Imatra (FI); Katja Lyytikäinen, Imatra (FI)

(73) Assignee: Stora Enso OYJ, Helsinki (FI)

(21) Appl. No.: 18/729,241

(22) PCT Filed: Jan. 31, 2023
(86) PCT No.: PCT/IB2023/050835

§ 371 Date: Jul. 16, 2024

(30) Foreign Application Priority Data
Feb. 10, 2022 (SE) 2250127-4

(51) Int. Cl. D21H 21/14; B32B 29/00; B32B 29/06; D21H 11/18; D21H 19/12; D21H 27/10

(52) U.S. Cl. CPC D21H 21/14; B32B 29/005; B32B 29/06; D21H 11/18; D21H 19/12; D21H 27/10; B32B 2250/02; B32B 2250/26; B32B 2255/12; B32B 2307/718; B32B 2307/7244; B32B 2307/7246; B32B 2439/70

(57) ABSTRACT

The present invention relates to a method for preparing a surface-treated gas barrier film, said method comprising the steps of: a) providing a gas barrier substrate comprising at least 50 wt % of a highly refined cellulose pulp based on dry weight; and b) surface treatment of the gas barrier substrate, wherein the surface treatment comprises treating a surface of the gas barrier substrate with a solution comprising an organic acid and sodium carbonate and drying the gas barrier substrate to obtain a surface-treated gas barrier film. The invention further relates to a surface-treated gas barrier film obtained according to the method and a packaging laminate comprising the surface-treated gas barrier film.

### TECHNICAL FIELD

The present disclosure relates to methods for improving the water vapor barrier properties of gas barrier substrates or films comprising highly refined cellulose pulp.

### BACKGROUND

Films and coatings made from highly refined cellulose pulp, including films made from microfibrillated cellulose (MFC), are known to provide high resistance to oil and greases as well as oxygen. The water vapor barrier properties of these films or coatings are known to be poor and insufficient for many types of packaging and other end use applications.

Barrier resistance to moisture and water vapor is not only required for packaging of aseptic products but may also be important for protecting dry food products and dairy products, particularly in humid conditions or when packages are subjected to rapid temperature changes leading to formation of condensation.

Various solutions, including a number of cross-linking agents, have been proposed in the patent and scientific literature to improve the moisture sensitivity of films comprising highly refined cellulose pulp such as MFC.

The problem with many of these solutions, is that they are not industrially scalable or suitable for high speed large scale manufacturing. Mixing and modification of MFC is technically difficult and may lead to problems with unbalanced wet end charge, corrosion, deposits in the wet-end section, or insufficient chemical and fiber retention. The use of crosslinking agents in the MFC furnish may also lead to uncontrolled or heterogenous cross-linking and insoluble gel precipitation, which will influence dewatering rate and subsequent film and barrier quality.

One solution contemplated involves soaking of the films in a solution comprising divalent or multivalent metal ions and then drying the films. However, the use of metal ions suffers from the limitation that the complexing is more efficient for more anionic cellulose substrates, such as TEMPO modified cellulose.

There remains a need for improved solutions to render gas barrier films comprising highly refined cellulose pulp more resistant to water vapor. The method should allow for high speed large scale manufacturing using safe and low cost materials.

### DESCRIPTION OF THE INVENTION

It is an object of the present disclosure to provide a method for surface treatment of a gas barrier substrate comprising a highly refined cellulose pulp, such as microfibrillated cellulose (MFC), wherein the surface-treated gas barrier film has a lower water vapor transfer rate (WVTR) than the gas barrier substrate.

It is a further object of the present disclosure to provide a method for surface treatment of a gas barrier substrate comprising a highly refined cellulose pulp, which reduces the WVTR while still retaining a low oxygen transfer rate (OTR).

It is a further object of the present disclosure to provide a method for surface treatment of a gas barrier substrate comprising a highly refined cellulose pulp, which reduces the WVTR, and which allows for high speed large scale film manufacturing.

The above-mentioned objects, as well as other objects as will be realized by the skilled person in the light of the present disclosure, are achieved by the various aspects of the present disclosure.

The present invention is based on the inventive realization that a solution of an organic acid and sodium carbonate (Na₂CO₃) can be used to significantly reduce the water vapor transfer rate (WVTR) of a gas barrier substrate comprising a highly refined cellulose pulp. Without wishing to be bound to any specific theory, it is believed that the organic acid combined with the sodium carbonate reacts with and crosslinks cellulose and other polysaccharides in the gas barrier substrate, reducing the solubility or swellability of the substrate, leading to the reduced WVTR. Sodium carbonate has been found to be especially useful in the surface treatment solution. In addition to providing a pH buffering effect and partially neutralizing the organic acid, it may be speculated that the sodium carbonate may also have a catalytic effect on the crosslinking reaction.

According to a first aspect illustrated herein, there is provided a method for preparing a surface-treated gas barrier film, said method comprising the steps of:
a) providing a gas barrier substrate comprising at least 50 wt % of a highly refined cellulose pulp based on dry weight, wherein the highly refined cellulose pulp has a Schopper Riegler (SR) value in the range of 80-100 according to standard ISO 5267-1; and
b) surface treatment of the gas barrier substrate, wherein the surface treatment comprises treating a surface of the gas barrier substrate with a solution comprising an organic acid and sodium carbonate and drying the gas barrier substrate to obtain a surface-treated gas barrier film.

The gas barrier substrate provided in step a) comprises at least 50 wt % of a highly refined cellulose pulp based on dry weight. In some embodiments, the gas barrier substrate provided in step a) comprises at least 70 wt %, preferably at least 90 wt % of a highly refined cellulose pulp based on dry weight.

The gas barrier substrate provided in step a) comprises a highly refined cellulose pulp. Refining, or beating, of cellulose pulps refers to mechanical treatment and fibrillation of the cellulose fibers in order to increase their surface area and provide them with desired properties.

The highly refined cellulose pulp of step a) has a Schopper Riegler (SR) value in the range of 80-100 according to standard ISO 5267-1. In some embodiments, the highly refined cellulose pulp has a Schopper Riegler (SR) value in the range of 85-100, more preferably in the range of 90-100 according to standard ISO 5267-1.

In some embodiments, the highly refined cellulose pulp is a microfibrillated cellulose.

Microfibrillated cellulose (MFC) shall in the context of the patent application mean a cellulose particle, fiber or fibril having a width or diameter of from 20 nm to 1000 nm.

Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicellulose or lignin. In some embodiments, the MFC is made from native unmodified cellulose. In other embodiments, the cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by N-oxyl mediated oxidation, for example “TEMPO”), or quaternary ammonium (cationic cellulose). After being modified or oxidized in one of the above-described methods, it is easier to disintegrate the fibers into MFC.

MFC can be produced from wood cellulose fibers, both from hardwood or softwood fibers. It can also be made from microbial sources, agricultural fibers such as wheat straw pulp, bamboo, bagasse, or other non-wood fiber sources. It can be made from pulp, including pulp from virgin fiber, e.g. mechanical, chemical and/or thermomechanical pulps. It can also be made from broke or recycled paper.

In some embodiments, the gas barrier substrate provided in step a) is provided in the form of a free-standing film or in the form of a coating on a paper or paperboard base substrate.

The term film as used herein refers generally to a thin continuous sheet formed material. Depending on its composition, purpose and properties, the film can also be considered as a thin paper or web, or even as a membrane.

The gas barrier substrate may generally have a grammage in the range of 0.1-100 g/m². A gas barrier substrate provided in the form of a free-standing film may typically have a grammage in the range of 5-100 g/m², preferably in the range of 10-50 g/m². A gas barrier substrate provided in the form of a coating may preferably have a grammage in the range of 0.1-20 g/m².

The gas barrier substrate may for example be manufactured by applying a highly refined cellulose pulp suspension on a porous wire or a porous substrate forming a web followed by dewatering of the web by draining water through the porous wire or substrate. Further dewatering of the web may be performed by techniques known in the art, such as press dewatering in a press section. Drying of the dewatered web to form the film may include hot air drying, drying on a hot or warm cylinder or metal belt, irradiation drying or vacuum drying, etc.

Formation of the web can be accomplished e.g. by use of a paper- or paperboard machine type of process such as the Fourdrinier process. The porous substrate may for example be a membrane or wire fabric or it can be a paper or paperboard substrate. The gas barrier substrate can also be prepared as a cast formed film, e.g. by cast forming on a non-porous substrate such as a metal or polymer belt. The gas barrier substrate can be a single ply or multiply substrate or a single layer or multilayer substrate.

Alternatively, when the gas barrier substrate is provided in the form of a coating on a paper or paperboard base substrate, the highly refined cellulose pulp suspension can for example be applied on the paper or paperboard base substrate by a coating method selected from film press, blade coating, curtain coating, spray coating, rod coating, gravure, rotogravure, and reverse gravure. The coating can be single layer or multiple layer coating. The coating can be applied on one or both sides of the base substrate. The coating can also be performed as wet on wet, wherein the cellulose pulp suspension is applied to a wet paper or paperboard base substrate in the wet end section.

The substrate provided in step a) is a gas barrier substrate. The term gas barrier substrate as used herein refers to a substrate which has a low permeability to gases, and particularly to oxygen. More specifically, the oxygen transfer rate (OTR) of the gas barrier substrate provided in step a) is preferably below 50 cc/m²/24 h, preferably below 30 cc/m²/24 h, and more preferably below 10 cc/m²/24 h, measured according to the standard ASTM D-3985 at 23° C. and 50% RH. Such a gas barrier substrate may advantageously be used as a gas barrier layer in a packaging laminate.

The gas barrier substrate provided in step a) is subjected to a surface treatment step to reduce the WVTR of the gas barrier substrate. The surface treatment comprises treating a surface of the gas barrier substrate with a solution comprising an organic acid and sodium carbonate and drying the gas barrier substrate to obtain a surface-treated gas barrier film.

The surface treatment involves bringing the surface of the gas barrier substrate into contact with a solution comprising an organic acid and sodium carbonate. In some embodiments, the treatment comprises applying a solution comprising both the organic acid and the sodium carbonate to the substrate surface. In some embodiments, an organic acid solution and a sodium carbonate solution are applied sequentially, such that a solution comprising both organic acid and sodium carbonate is formed on the gas barrier substrate surface. Sequential addition, wherein the organic is added first and the sodium carbonate is added later could also help to neutralize excess acid that could otherwise have a negative impact on OTR of the finished film. One or both of the organic acid and sodium carbonate may also be applied to the gas barrier substrate surface in dry form, such as in powder form, and then dissolved by wetting the gas barrier substrate surface with water or with a solution of the other of the organic acid and sodium carbonate, such that a solution comprising both organic acid and sodium carbonate is formed on the substrate surface.

In some embodiments, the gas barrier substrate provided in step a) is dry when the solution or solutions is applied. The term “dry” as used herein means that the gas barrier substrate has a dry content above 80%, preferably above 90%, and more preferably above 95% by weight.

In some embodiments, the gas barrier substrate provided in step a) is calendered, preferably machine calendered or soft nip calendered. The gas barrier substrate can for example be calendered in one or several hard nips, a belt calender, an extended nip calender, or a combination thereof.

Depending on the structure and porosity of the gas barrier substrate surface and the composition of the solution, the treatment may constitute a coating, wherein the solution forms a layer at the gas barrier substrate surface, or an impregnation, wherein the solution penetrates into the gas barrier substrate, or a combination of a coating and an impregnation.

Preferably, both the organic acid and sodium carbonate are readily water soluble in water at the treatment temperature.

In some embodiments, the organic acid is selected from the group consisting of tartaric acid, citric acid, lactic acid, acetic acid, formic acid, oxalic acid, uric acid, 1,2,3,4-butanetetracarboxylic acid, and combinations thereof.

In preferred embodiments, the organic acid is a difunctional or multifunctional acid, i.e. an organic acid having two or more carboxyl functional groups. In some embodiments, the organic acid is selected from the group consisting of tartaric acid and citric acid and combinations thereof, more preferably tartaric acid.

In some embodiments, the concentration of the organic acid in the solution is in the range of 5-60 wt %, preferably in the range of 10-50 wt %, and more preferably in the range of 20-40 wt %.

In some embodiments, the concentration of the sodium carbonate in the solution is in the range of 0.1-20 wt %. In some embodiments, the concentration of the sodium carbonate in the solution, or added to the solution, is in the range of 0.5-15 wt %, preferably in the range of 1-10 wt %, and more preferably in the range of 1-5 wt %.

The sodium carbonate is likely to be converted, at least partially, into other species in the solution. Thus, in some embodiments the amount of sodium carbonate added to the solution corresponds to a concentration in the range of 0.1-20 wt %. In some embodiments, the amount of sodium carbonate added to the solution corresponds to a concentration in the range of 0.5-15 wt %, preferably in the range of 1-10 wt %, and more preferably in the range of 1-5 wt %.

In some embodiments, the weight ratio of organic acid: sodium carbonate in the solution, or added to the solution, is in the range of 100:1 to 1:1, preferably in the range of 50:1 to 2:1, and more preferably in the range of 25:1 to 5:1, based on dry weight.

In some embodiments, the solution or solutions may further comprise a second base, preferably NaOH or KOH. The concentration of the second base in the solution may be in the range of 0.1-30 wt %.

The solution or solutions may further comprise a water-soluble polymer. The water-soluble polymer can be used to modify the viscosity of the solution, facilitating the application and retention of the applied organic acid and sodium carbonate at the gas barrier substrate surface. Thus, in embodiments where a water-soluble polymer is used, the solution may take the form of a coating rather than an impregnation. The water-soluble polymer is soluble in cold water or soluble in water after heating to a temperature below 100° C. for a given period of time. In some embodiments, the solution comprises a water-soluble polymer at a concentration in the range of 0.1-30 wt %. The water-soluble polymer may for example be a water-soluble polysaccharide or polyvinyl alcohol (PVOH), or a derivative thereof. In some embodiments the water-soluble polymer is a water-soluble polysaccharide. In some embodiments the water-soluble polymer is a water-soluble starch derivative or a water-soluble cellulose derivative. Examples of suitable cellulose derivatives include, but are not limited to, carboxymethyl cellulose (CMC), hydroxyethyl cellulose (HEC), ethylhydroxyethyl cellulose (EHEC), and hydroxypropyl cellulose (HPC). In some embodiments the water-soluble polymer is a water-soluble polyvinyl alcohol (PVOH) or a derivative thereof.

The solution is buffered by the sodium carbonate. Thus, the solution will preferably have a neutral or weakly acidic pH. In some embodiments, the pH of the solution is in the range of 1-5, preferably in the range of 1-3, and more preferably in the range of 1-2.

The solution or solutions may be applied to gas barrier substrate using conventional coating or application methods well known in the art. Examples of suitable coating or application methods include, but are not limited to, size press, film press, immersion, spray coating, curtain coating, printing, such as flexography or rotogravure printing, or anilox or gravure or reverse gravure or rod coating.

In some embodiments, the solution or solutions is applied in the form of a foam. Foam coating is advantageous as it allows for film forming at higher solids content and lower water content compared to a non-foamed coating. The lower water content of a foam coating also reduces the problems with rewetting of the substrate. The foam may be formed using a polymeric or non-polymeric foaming agent. Examples of polymeric foaming agents include PVOH and derivatives thereof, hydrophobically modified starch, and hydrophobically modified ethyl hydroxyethyl cellulose.

The surface-treated gas barrier substrate is dried to obtain a surface-treated gas barrier film. The surface-treated gas barrier substrate is preferably dried to a dry content above 80%, preferably above 90%, and more preferably above 95% by weight. Suitable drying steps include contact dryers such as drying cylinders, yankee dryers and metal belt dryers, or non-contact dryers such as hot air dryers and radiation dryers (for example IR dryers).

The reaction of the organic acid and sodium carbonate with the gas barrier substrate material can be accelerated by increasing the temperature above room temperature. The increased temperature can be applied during or after the application of the solution, such as during the drying of the gas barrier substrate to obtain the surface-treated gas barrier film. In some embodiments, the solution is applied at a temperature above 40° C., preferably above 50° C., and more preferably above 60° C. Besides increasing the reaction rate, this higher temperature of the solution may also increase solubility of the organic acid and sodium carbonate, and an optional water-soluble polymer, in the solution.

In some embodiments, the drying is performed at a temperature above 40° C., preferably above 50° C., and more preferably above 60° C.

It has also been found that the WVTR can be further improved by subjecting the obtained dried surface-treated gas barrier film to a further heat treatment or curing step. Thus, in some embodiments, the surface treatment further comprises subjecting the dried surface-treated gas barrier film to heat treatment at a temperature above 80° C., preferably above 90° C., and more preferably above 100° C. The heat treatment is typically performed for a time of 10 seconds to 60 minutes, preferably 1-60 minutes, preferably 1-30 minutes.

In some embodiments, the obtained dried surface-treated gas barrier film is further subjected to a calendering step. In some embodiments, the calendering step comprises machine calendering and/or soft nip calendering.

The surface treatment reduces the WVTR of the gas barrier substrate provided in step a). Preferably, the surface treatment also preferably retains the oxygen transfer rate (OTR) of the gas barrier substrate at the same low level as before the surface treatment. In other words, the WVTR of the gas barrier substrate is reduced without at the same time compromising the oxygen barrier properties of the gas barrier substrate.

In some embodiments, the oxygen transfer rate (OTR) of the gas barrier substrate provided in step a) is below 50 cc/m²/24 h, preferably below 30 cc/m²/24 h, and more preferably below 10 cc/m²/24 h, measured according to the standard ASTM D-3985 at 23° C. and 50% RH.

In some embodiments, the oxygen transfer rate (OTR) of the surface-treated gas barrier film obtained in step b) is below 50 cc/m²/24 h, preferably below 30 cc/m²/24 h, and more preferably below 10 cc/m²/24 h, measured according to the standard ASTM D-3985 at 23° C. and 50% RH.

The surface-treated gas barrier film obtained in step b) has a lower Water Vapor Transmission Rate (WVTR) determined according to ASTM F-1249 at 23° C. and 50% RH than the gas barrier substrate provided in step a).

In some embodiments, the WVTR of the surface-treated gas barrier film obtained in step b) is less than 30%, preferably less than 20%, more preferably less than 10%, of the WVTR of the gas barrier substrate provided in step a), determined according to ASTM F-1249 at 23° C. and 50% RH.

In some embodiments, the WVTR of the gas barrier substrate provided in step a) is above 50 g/m²/24 h, preferably above 80 g/m²/24 h, and more preferably above 100 g/m²/24 h determined according to ASTM F-1249 at 23° C. and 50% RH.

In some embodiments, the WVTR of the surface-treated gas barrier film obtained in step b) is below 30 g/m²/24 h, preferably below 20 g/m²/24 h, and more preferably below 10 g/m²/24 h determined according to ASTM F-1249 at 23° C. and 50% RH.

The surface pH of the treated surface of the surface-treated gas barrier film or substrate is preferably in the range of 1-5, more preferably in the range of 1-3, and more preferably in the range of 2-3. This relatively low surface pH may be useful as it may improve bonding to subsequently applied coatings or layers. In some embodiments, the surface pH of the treated surface of the surface-treated gas barrier film may also be higher, e.g. due to a high pH in the substrate starting material, or due to added base (e.g. NaOH or KOH) in the treatment solution. Thus, in some embodiments, the surface pH of the treated surface of the surface-treated gas barrier film or substrate is preferably in the range of 5-9, more preferably in the range of 6-8. The surface pH is measured on the final product, i.e. the dry product. The surface pH is measured using fresh pure water which is placed on the surface. Five parallel measurements are performed and the average pH value is calculated. The sensor is flushed with pure or ultra-pure water and the paper sample is then placed on the moist/wet sensor surface and pH is recorded after 30 s. Standard pH meters are used for the measurement.

According to a second aspect illustrated herein, there is provided a surface-treated gas barrier film obtained according to the first aspect. The surface-treated gas barrier film may be in the form of a free-standing film or in the form of a coating on a paper or paperboard base substrate. The surface-treated gas barrier film may be further defined as set out above with reference to the first aspect.

The surface-treated gas barrier film is suitable for being laminated to a paper or paperboard base substrate. The surface-treated gas barrier film may also be subjected to additional treatment to further improve its barrier or other properties. The surface-treated gas barrier film may for example be provided with a vacuum deposition layer (such as a vacuum deposition layer comprising aluminum or aluminum oxide) or be provided with further coating layers to improve barrier properties or to provide other characteristics, such as heat sealability.

According to a third aspect illustrated herein, there is provided a packaging laminate comprising a surface-treated gas barrier film obtained according to the first aspect attached to a base substrate, preferably a paper or paperboard base substrate. The surface-treated gas barrier film may be further defined as set out above with reference to the first or second aspect.

In preferred embodiments, the base substrate is a paper or paperboard base substrate and the packaging laminate is a paper or paperboard based packaging laminate.

Paper generally refers to a material manufactured in thin sheets from the pulp of wood or other fibrous substances comprising cellulose fibers, used for writing, drawing, or printing on, or as packaging material.

Paperboard generally refers to strong, thick paper or cardboard comprising cellulose fibers used for boxes and other types of packaging. Paperboard can either be bleached or unbleached, coated or uncoated, and produced in a variety of thicknesses, depending on the end use requirements.

A paper or paperboard based packaging laminate is a packaging material formed mainly from paper or paperboard. It can be made from pulp, including pulp from virgin fiber, e.g. mechanical, chemical and/or thermomechanical pulps. It can also be made from broke or recycled paper. In addition to paper or paperboard, the paper or paperboard based packaging laminate may typically comprise additional layers or coatings designed to improve the performance and/or appearance of the packaging laminate.

The paper or paperboard based packaging laminate typically has a first outermost surface intended to serve as the outside surface, or print side, and a second outermost surface intended to serve as the inside surface of a packaging container.

Additionally, the inventive paper or paperboard based packaging laminate can provide an alternative to conventional materials using aluminum foil layers, which can more readily be repulped and recycled. In some embodiments, the packaging laminate has a repulpability characterized by a reject rate (as determined according to the PTS RH 021/97 test method) below 20%, preferably below 10%, and more preferably below 5%.

One advantage of the present invention is that the surface treatment can reduce the need for a plastic layer as an outermost layer coated or laminated onto the surface-treated gas barrier film. However, in some applications it may still be desired to provide the surface-treated gas barrier film with a protective polymer layer. The surface-treated gas barrier film may further comprise at least one protective polymer layer disposed on a surface thereof. The protective polymer layer preferably comprises a thermoplastic polymer. The polymer layer may for example comprise any of the polymers commonly used in paper-based or paperboard-based packaging materials in general. Examples include polyethylene (PE), polyethylene terephthalate (PET), polypropylene (PP), polylactic acid (PLA), polyhydroxyalkanoates (PHA) and polyvinyl alcohol (PVOH). Polyolefins, especially low-density polyethylene (LDPE) and high-density polyethylene (HDPE), are the most common and versatile polymers used.

Thermoplastic polymers, and particularly polyolefins are useful since they can be conveniently processed by extrusion coating techniques to form very thin and homogenous films with good barrier properties. In preferred embodiments, the polymer layer comprises a polyethylene, more preferably LDPE or HDPE.

The protective polymer layer is preferably made of a polymer obtained from renewable resources.

The basis weight of the protective polymer layer is preferably less than 50 g/m². In order to achieve a continuous and substantially defect free film, a basis weight of the polymer layer of at least 4 g/m², preferably at least 8 g/m², is typically required, depending on the polymer used. In some embodiments, the basis weight of the polymer layer is in the range of 4-15 g/m² or in the range of 15-30 g/m².

Generally, while the products, compositions, materials, layers and processes are described in terms of “comprising” various components or steps, the products, compositions, materials, layers and processes can also “consist essentially of” or “consist of” the various components and steps.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

### EXAMPLES

In all Examples, the gas barrier substrate was prepared from 100% kraft pulp refined to a Schopper Riegler (SR) value about 95 according to the ISO 5267-1 standard. The pH of the pulp vas 7.2, the amount of long (>0.2 mm) fibers was 19.8 million fibers/g, and the Fines A content was 47% and fines B content was 47% as determined by the FS5 method (5 μm setting).

All films were formed as a web on a wire at a low consistency and run through a wet press section and dried. The grammage of the dried web was 30 gsm and moisture content about 5% after drying.

### Example 1 (Comparative)—No Treatment

The gas barrier substrate was evaluated without any further surface treatment. The water vapor transmission rate WVTR of the gas barrier substrate was 91 g/m²/24 h determined at 23° C. and 50% RH (also referred to herein as 23/50). The oxygen transfer rate OTR of the gas barrier substrate was 10 cc/m²/day measured according to the standard ASTM D-3985 at 23° C. and 50% RH.

### Example 2 (Comparative)—Water Treatment

The same film as used in Example 1 was surface-treated with water. The WVTR determined for the dried water treated sample was 140 g/m²/24 h (23/50). The WVTR decreased to 65 g/m²/24 h (23/50) after post curing at 150° C. for 5 min.

### Example 3 (Comparative)—Treatment With 30 wt % Tartaric Acid Solution

The same gas barrier substrate as used in Example 1 was surface-treated with 30 wt % tartaric acid solution (pH of the solution was 1.0) and then dried and additionally post-cured. WVTR of the dried film was 21 g/m²/24 h (23/50). The WVTR decreased to 10 g/m²/24 h (23/50) after post curing at 150° C. for 5 min. The surface pH of the film was 1.37. The surface pH was measured using fresh pure water which was placed on the surface. Five parallel measurements were performed and the average pH value was calculated. The sensor was flushed with ultra-pure water and the paper sample was then placed on the wet sensor surface and pH was recorded after 30 s. A standard pH meter was used for the measurement.

### Example 4—Treatment With 30 wt % Tartaric Acid and 2.5 wt % Na₂CO₃

The same gas barrier substrate as used in Example 1 was surface-treated with an aqueous solution containing 30 wt % tartaric acid and 2.5 wt % Na₂CO₃ (pH of the solution was 1.7) and then dried and further post cured at 150° C. for 5 min. The WVTR of the dried film was 7 g/m²/24 h (23/50). The WVTR decreased to 2 g/m²/24 h (23/50) after post curing at 150° C. for 5 min. The surface pH of the film was 2.28. The surface pH was determined as in Example 3.

1. A method for preparing a surface-treated gas barrier film, said method comprising the steps of:
a) providing a gas barrier substrate comprising at least 50 wt % of a highly refined cellulose pulp based on a dry weight, wherein the highly refined cellulose pulp has a Schopper Riegler (SR) value in a range of 80-100 according to standard ISO 5267-1; and
b) surface treatment of the gas barrier substrate, wherein the surface treatment comprises treating a surface of the gas barrier substrate with a solution comprising an organic acid and sodium carbonate, and drying the gas barrier substrate to obtain a surface-treated gas barrier film.

2. The method according to claim 1, wherein the gas barrier substrate provided in step a) comprises at least 70 wt % of the highly refined cellulose pulp based on the dry weight.

3. The method according to claim 1, wherein the highly refined cellulose pulp has a Schopper Riegler (SR) value in a range of 85-100, according to standard ISO 5267-1.

4. The method according to claim 1, wherein the highly refined cellulose pulp comprises microfibrillated cellulose.

5. The method according to claim 1, wherein the gas barrier substrate provided in step a) comprises a free-standing film or a coating on a paper or paperboard base substrate.

6. The method according to claim 1, wherein a grammage of the gas barrier substrate provided in step a) is in a range of 5-100 g/m².

7. The method according to claim 1, wherein the organic acid is selected from a group consisting of: tartaric acid, citric acid, lactic acid, acetic acid, formic acid, oxalic acid, uric acid, 1,2,3,4-butanetetracarboxylic acid, and combinations thereof.

8. The method according to claim 1, wherein a concentration of the organic acid in the solution is in a range of 5-60 wt %.

9. The method according to claim 1, wherein a concentration of the sodium carbonate in the solution is in a range of 0.5-15 wt %.

10. The method according to claim 1, wherein the solution further comprises a water-soluble polymer at a concentration in a range of 0.1-30 wt %.

11. The method according to claim 1, wherein a pH of the solution is in a range of 1-5.

12. The method according to claim 1, wherein the solution is applied at a temperature above 40° C.

13. The method according to claim 1, wherein the drying is performed at a temperature above 40° C.

14. The method according to claim 1, wherein the surface treatment further comprises subjecting a dried surface-treated gas barrier film to a heat treatment at a temperature above 80° C.

15. The method according to claim 1, wherein the an oxygen transfer rate (OTR) of the gas barrier substrate provided in step a) is below 50 cc/m²/24 h, measured according to ASTM D-3985 at 23° C. and 50% RH.

16. The method according to claim 1, wherein an oxygen transfer rate (OTR) of the surface-treated gas barrier film obtained in step b) is below 50 cc/m²/24 h, measured according to ASTM D-3985 at 23° C. and 50% RH.

17. The method according to claim 1, wherein the surface-treated gas barrier film obtained in step b) has a lower Water Vapor Transmission Rate (WVTR) determined according to ASTM F-1249 at 23° C. and 50% RH than the gas barrier substrate provided in step a).

18. The method according to claim 1, wherein the a Water Vapor Transmission Rate (WVTR) of the surface-treated gas barrier film obtained in step b) is less than 30%, of a Water Vapor Transmission Rate of the gas barrier substrate provided in step a), determined according to ASTM F-1249 at 23° C. and 50% RH.

19. The method according to claim 1, wherein a Water Vapor Transmission Rate of the gas barrier substrate provided in step a) is above 50 g/m²/24 h, determined according to ASTM F-1249 at 23° C. and 50% RH.

20. The method according to claim 1, wherein a Water Vapor Transmission Rate of the surface-treated gas barrier film obtained in step b) is below 30 g/m²/24 h, determined according to ASTM F-1249 at 23° C. and 50% RH.

21. A surface-treated gas barrier film obtained according to the method of claim 1.

22. A packaging laminate comprising:
a surface-treated gas barrier film obtained according to the method of claim 1, the surface-treated gas barrier film attached to a base substrate.
